(19) United States
(12) Patent Application Publication
(10) Pub. No.: US 2025/0102894 A1
(43) Pub. Date: Mar. 27, 2025

(54) ILLUMINATION SYSTEM AND PROJECTION DEVICE

(71) Applicant: Coretronic Corporation, Hsin-Chu (TW)

(72) Inventors: Chang-Hsuan Chen, Hsin-Chu (TW); Hou-Sheng Wang, Hsin-Chu (TW); Shao-Hui Liu, Hsin-Chu (TW)

(73) Assignee: Coretronic Corporation, Hsin-Chu (TW)

(21) Appl. No.: 18/896,808

(22) Filed: Sep. 25, 2024

(30) Foreign Application Priority Data
Sep. 26, 2023 (CN) 202311246508.5

(51) Int. Cl. G03B 21/20; G02B 26/00

(52) U.S. Cl. CPC G03B 21/204; G02B 26/008; G03B 21/2066

(57) ABSTRACT

An illumination system includes a first light source, a second light source, a light combining module, and a wavelength conversion element. The first light source is configured to provide a first beam. The second light source is configured to provide a second beam. The light combining module is disposed on a transmission path of the first beam from the first light source and the second beam from the second light source. The wavelength conversion element includes a rotary disk, a wavelength conversion material layer, and a light splitting layer. The light splitting layer is disposed on the rotary disk. The wavelength conversion material layer is disposed between the rotary disk and the light splitting layer, and is configured to convert the first beam into an excited beam. The light splitting layer is configured to reflect the second beam and allow the first beam and the excited beam to pass through.

### CROSS-REFERENCE TO RELATED APPLICATION

This application claims the priority benefit of China application serial no. 202311246508.5, filed on Sep. 26, 2023. The entirety of the above-mentioned patent application is hereby incorporated by reference herein and made a part of this specification.

### BACKGROUND

### Technical Field

The disclosure relates to an optical system and an electronic device, and in particular to an illumination system and a projection device.

### Description of Related Art

The projection device is a display device configured to generate a large-size image and has been constantly improving with the evolution and innovation of science and technology. The imaging principle of the projection device is to convert an illumination beam generated by an illumination system into an image beam by a light valve, and then project the image beam through a projection lens onto a projection target (for example, a screen or wall) to form a projection image. In addition, following market requirements such as brightness, color saturation, service life, non-toxicity, and environmental friendliness of the projection device, the illumination system has also evolved all the way from ultra-high-performance (UHP) lamp and light emitting diode (LED) to the most advanced laser diode (LD) light source, and even a packaged light source formed by a multi-in-one laser diode has been released, so that the internal configuration of the projection device is more compact and the optical performance is better.

The current simulation projector configured to be applied to flight simulation, navigation simulation, driving simulation, and night vision training are provided with an infrared light source to provide an infrared light. However, in the current existing projector model, an additional infrared light source needs to be added if the infrared light is to be provided and cannot be disposed in the same optical path as the main light source. Therefore, the volume of the model is too large to use the same housing as the existing models. In addition, in the existing optical path structure, the infrared light source cannot be directly combined with the existing optical path.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides an illumination system and a projection device that can provide an additional infrared light for applications in different fields without adding an additional optical lens to maintain a good size, so that a housing of an existing model can continue to be used.

Other objectives and advantages of the disclosure can be further understood from the technical features disclosed in the disclosure.

In order to achieve one, part, or all of the above objectives or other objectives, the disclosure provides an illumination system configured to provide an illumination beam. The illumination system includes a first light source, a second light source, a light combining module, and a wavelength conversion element. The first light source is configured to provide a first beam, and the first beam is a laser beam. The second light source is configured to provide a second beam. A wavelength range of the first beam is different from a wavelength range of the second beam. The light combining module is disposed on a transmission path of the first beam from the first light source and the second beam from the second light source, so that the first beam and the second beam have the same transmission path between the light combining module and the wavelength conversion element. The wavelength conversion element includes a rotary disk, a wavelength conversion material layer, and a light splitting layer. The light splitting layer is disposed on the rotary disk, and the wavelength conversion material layer is disposed between the rotary disk and the light splitting layer. The wavelength conversion material layer is configured to convert the first beam into an excited beam. The light splitting layer is configured to reflect the second beam and allow the first beam and the excited beam to pass through. When the first light source is turned on and the second light source is turned off, the illumination beam includes at least one of the first beam and the excited beam. When the first light source and the second light source are both turned on, the illumination beam includes at least one of the first beam, the second beam, and the excited beam.

In order to achieve one, a part, or all of the above objectives or other objectives, the disclosure further provides a projection device, including an illumination system, at least one light valve, and a projection lens. The illumination system is configured to provide an illumination beam. The illumination system includes a first light source, a second light source, a light combining module, and a wavelength conversion element. The first light source is configured to provide a first beam, and the first beam is a laser beam. The second light source is configured to provide a second beam. A wavelength range of the first beam is different from a wavelength range of the second beam. The light combining module is disposed on a transmission path of the first beam from the first light source and the second beam from the second light source, so that the first beam and the second beam have the same transmission path between the light combining module and the wavelength conversion element. The wavelength conversion element includes a rotary disk, a wavelength conversion material layer, and a light splitting layer. The light splitting layer is disposed on the rotary disk, and the wavelength conversion material layer is disposed between the rotary disk and the light splitting layer. The wavelength conversion material layer is configured to convert the first beam into an excited beam. The light splitting layer is configured to reflect the second beam and allow the first beam and the excited beam to pass through. When the first light source is turned on and the second light source is turned off, the illumination beam includes at least one of the first beam and the excited beam. When the first light source and the second light source are both turned on, the illumination beam includes at least one of the first beam, the second beam, and the excited beam. The at least one light valve is disposed on a transmission path of the illumination beam and is configured to convert the illumination beam into an image beam. The projection lens is disposed on a transmission path of the image beam and is configured to project the image beam out of the projection device.

Based on the above, embodiments of the disclosure have at least one of the following advantages or effects. In the illumination system and the projection device of the disclosure, the illumination system includes the first light source, the second light source, the light combining module, and the wavelength conversion element. The first light source is configured to provide the first beam, and the second light source is configured to provide the second beam. When the first beam and the second beam pass through the light combining module at the same time or at different times and are then transmitted to the wavelength conversion element along the same transmission path, the first beam passes through the light splitting layer to generate the excited beam by a region distributed with the wavelength conversion material layer or to be reflected by a region not distributed with the wavelength conversion material layer, and the second beam is reflected by the light splitting layer or is reflected by the region not distributed with the wavelength conversion material layer, so that the first beam, the second beam, and the excited beam respectively form the illumination beam according to the same or different timings. In this way, the projection device can provide the additional infrared light for applications in different fields without adding an additional optical lens to maintain a good size. On the other hand, the existing projection device model may also be upgraded, so that the housing of the existing model can continue to be used.

Other objectives, features and advantages of the disclosure will be further understood from the further technological features disclosed by the embodiments of the disclosure wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the disclosure.

FIG. 2A and FIG. 2B are respectively schematic diagrams of an illumination system at different timings according to an embodiment of the disclosure.

FIG. 2C is a schematic diagram of a first light source, a second light source, and a light combining module of the illumination system of FIG. 2A and FIG. 2B from another perspective.

FIG. 2D and FIG. 2E are respectively schematic diagrams of an illumination system at different timings according to another embodiment of the disclosure.

FIG. 2F is a timing diagram of an illumination system according to an embodiment of the disclosure.

FIG. 2G is another timing diagram of an illumination system according to an embodiment of the disclosure.

FIG. 3 is a schematic cross-sectional diagram of a wavelength conversion element according to an embodiment of the disclosure.

FIG. 4 is a schematic diagram of a light splitting element according to an embodiment of the disclosure.

FIG. 5A and FIG. 5B are respectively wavelength transmittance curves of different regions in the light splitting element of FIG. 4.

FIG. 6A and FIG. 6B are respectively schematic diagrams of a light splitting element according to different embodiments of the disclosure.

FIG. 7A and FIG. 7B are respectively wavelength transmittance curves of different regions in the light splitting element of FIG. 6A.

FIG. 8A to FIG. 8D are respectively wavelength transmittance curves of different regions in a filter element according to an embodiment of the disclosure.

FIG. 9 is a schematic cross-sectional diagram of a wavelength conversion element according to another embodiment of the disclosure.

FIG. 10 is a timing diagram of an illumination system according to another embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top”, “bottom”, “front”, “back”, etc., is used with reference to the orientation of the FIG. (s) being described. The components of the disclosure can be positioned in a number of different orientations. As such, the directional terminology is used for purposes of illustration and is in no way limiting. On the other hand, the drawings are turned only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

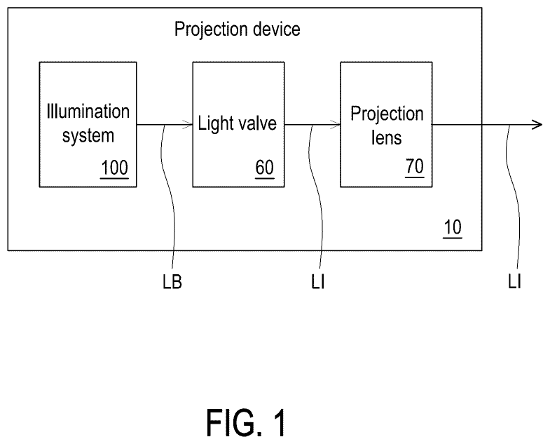

FIG. 1 is a schematic diagram of a projection device according to an embodiment of the disclosure Please refer to FIG. 1. The embodiment provides a projection device 10 including an illumination system 100, at least one light valve 60, and a projection lens 70. The illumination system 100 is configured to provide an illumination beam LB. The at least one light valve 60 is disposed on a transmission path of the illumination beam LB and is configured to convert the illumination beam LB into an image beam L1. The projection lens 70 is disposed on a transmission path of the image beam L1 and is configured to project the image beam L1 out of the projection device 10 onto a projection target (not shown), such as a screen or a wall.

The light valve 60 is, for example, a reflective light modulator such as a liquid crystal on silicon (LCoS) panel or a digital micro-mirror device (DMD). In some embodiments, the light valve 60 may also be a transmissive optical modulator such as a transparent liquid crystal panel, an electro-optic modulator, a magneto-optic modulator, or an acousto-optic modulator (AOM). The disclosure does not limit the form and the type of the light valve 60. Sufficient teachings, suggestions, and implementation descriptions of the detailed steps and implementation manners of the light valve 60 converting the illumination beam LB into the image beam L1 can be obtained from common knowledge in the art, so there will be no reiteration. In different embodiments, the number of the light valve 60 may be designed to be one to three, but the disclosure is not limited thereto.

The projection lens 70 includes, for example, a combination of one or more optical lenses with refractive power, such as various combinations of non-planar lenses such as biconcave lenses, biconvex lenses, concave-convex lenses, convex-concave lenses, plano-convex lenses, and plano-concave lenses. In an embodiment, the projection lens 70 may further include a planar optical lens to project the image beam L1 from the light valve 60 to the projection target in a reflective manner. The disclosure does not limit the form and the type of the projection lens 70.

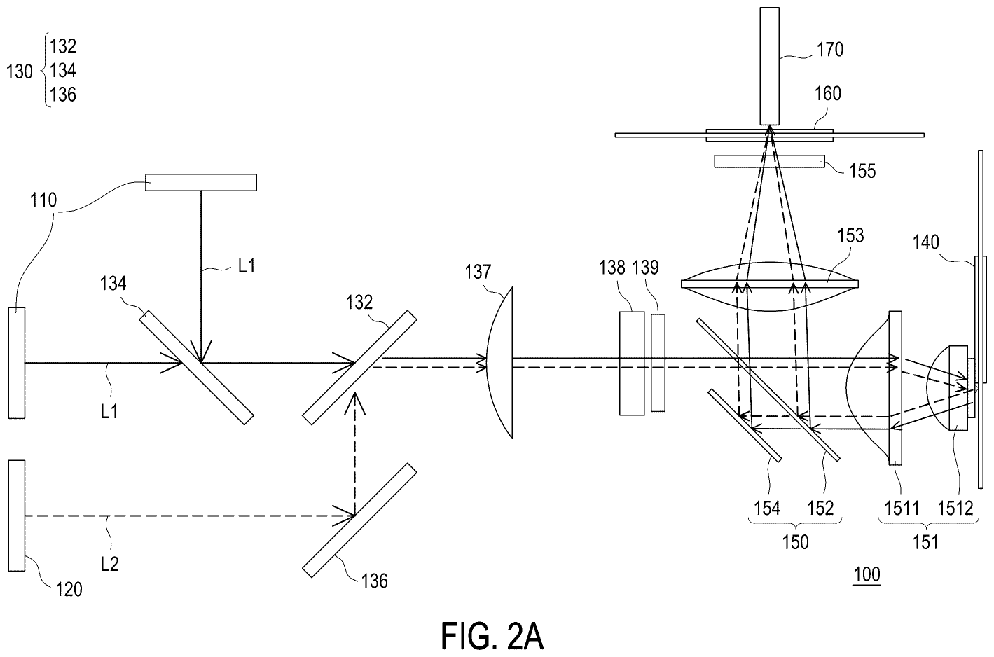

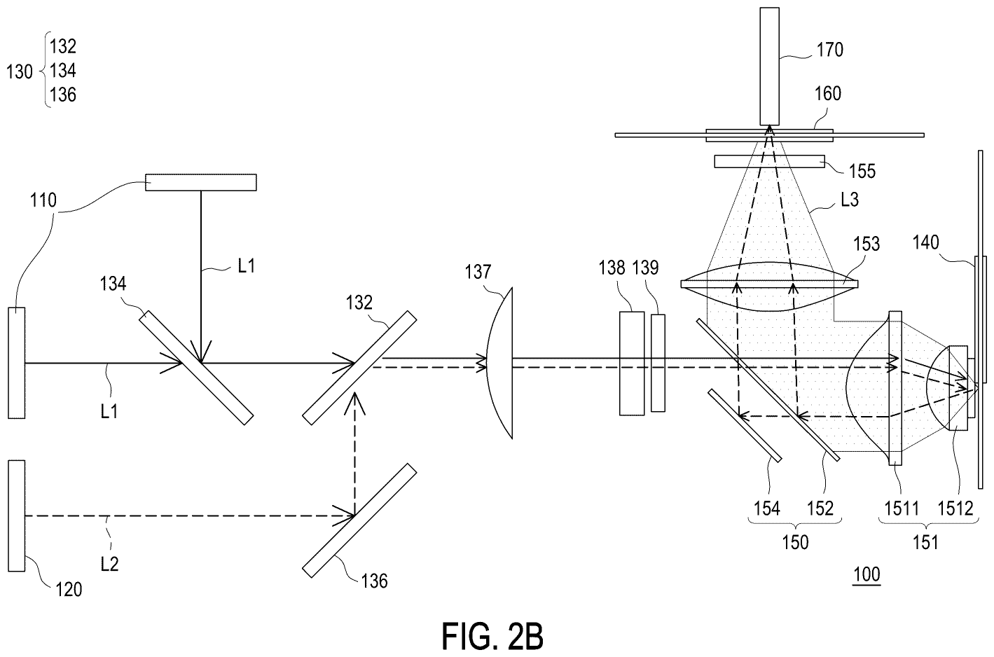

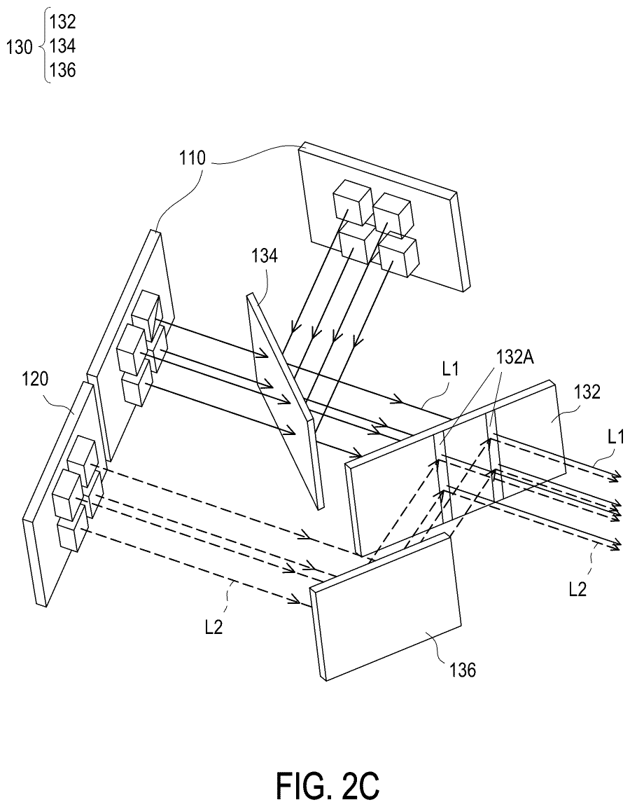

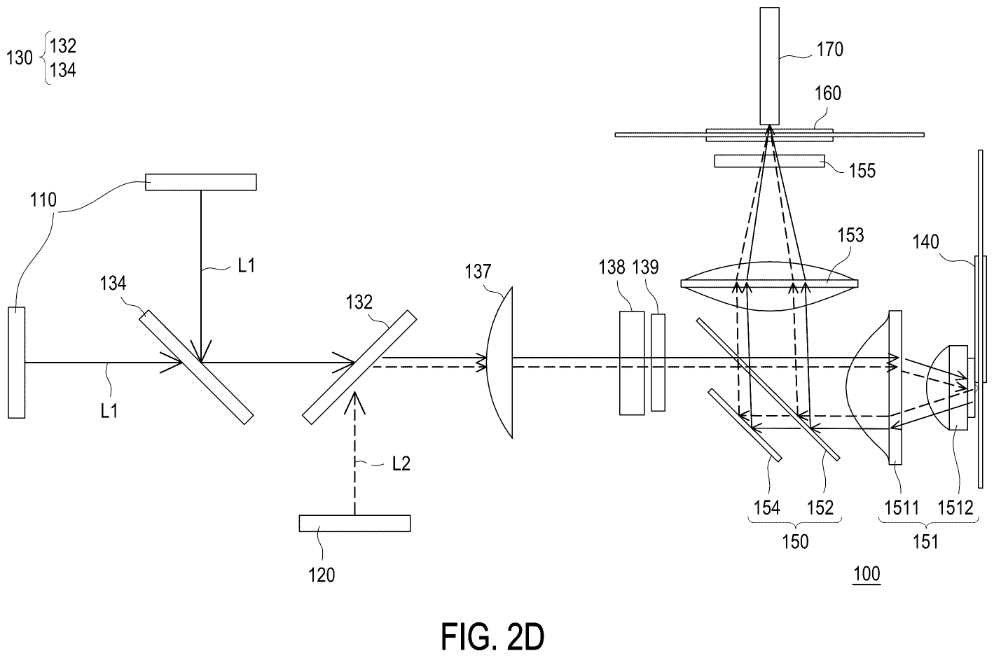

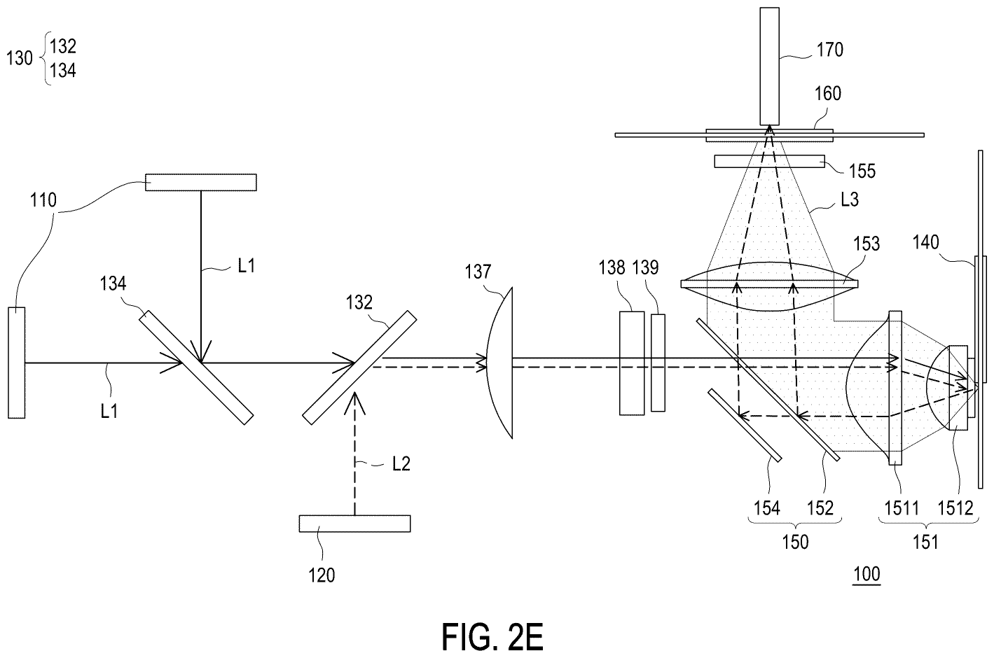

FIG. 2A and FIG. 2B are respectively schematic diagrams of an illumination system at different timings according to an embodiment of the disclosure. FIG. 2C is a schematic diagram of a first light source, a second light source, and a light combining module of the illumination system of FIG. 2A and FIG. 2B from another perspective. Please refer to FIG. 1 to FIG. 2B. The illumination system 100 shown in the embodiment may be at least applied to the illumination system 100 shown in FIG. 1, so the following description takes this as an example. The illumination system 100 includes a first light source 110, a second light source 120, a light combining module 130, and a wavelength conversion element 140. The first light source 110 is configured to provide a first beam L1, the second light source 120 is configured to provide a second beam L2, and a wavelength range of the first beam L1 is different from a wavelength range of the second beam L2. The first light source 110 and the second light source 120 include, for example, a light emitting diode (LED), a light emitting diode array, a laser diode (LD), or a laser diode array. In the embodiment, the first beam L1 is, for example, a blue laser beam, and the second beam L2 is, for example, an infrared laser beam. However, in different embodiments, the second beam L2 may be designed, for example, as a red laser beam with a dominant wavelength of 638 nm or a combination of the red laser beam and the infrared laser beam, but the disclosure is not limited thereto.

The light combining module 130 is disposed on a transmission path of the first beam L1 from the first light source 110 and the second beam L2 from the second light source 120, so that the first beam L1 and the second beam L2 may have the same transmission path between the light combining module 130 and the wavelength conversion element 140. For example, in the embodiment, the light combining module 130 includes a light combining element 132. The first beam L1 from the first light source 110 and the second beam L2 from the second light source 120 are respectively incident from two opposite sides of the light combining element 132, wherein one of the first beam L1 and the second beam L2 is reflected by the light combining element 132, and the other one of the first beam L1 and the second beam L2 passes through the light combining element 132. The light combining element 132 is, for example, a stripe mirror, but not limited thereto. As long as it is an element that can split light and combine light, the element falls within the protection scope of the disclosure. Please refer to FIG. 2C. Specifically, the light combining element 132 includes multiple strip-shaped coating areas 132A and multiple strip-shaped non-coating areas (not numbered) in a staggered arrangement. Each of the strip-shaped coating areas 132A is configured to reflect the second beam L2 and allow the first beam L1 to pass through. In another embodiment, the light combining element 132 is, for example, a light transmitting element, at least one of the two opposite sides of the light combining element 132 is provided with a dichroic film (not shown), one of the first beam L1 and the second beam L2 is reflected by the dichroic film of the light combining element 132, and the other one of the first beam L1 and the second beam L2 passes through the dichroic film of the light combining element 132. In the embodiment, the first light source 110 includes, for example, two sets of light emitting units (not numbered), each light emitting unit includes at least one light emitting diode or at least one laser diode, the light combining module 130 may also include another light combining element 134 and a reflective mirror 136, another light combining element 134 includes multiple strip-shaped reflective coatings (not numbered) and is configured to combine the first beam L1 from the two sets of light emitting units to be transmitted to the light combining element 132, and the reflective mirror 136 is configured to reflect the second beam L2 from the second light source 120 to the light combining element 132. In more detail, the illumination system 100 also includes a condenser lens 137, a collimating lens 138, a fly-eye lens array 139, a relay optical module 150, and a condenser lens set 151 (including a first condenser lens 1511 and a second condenser lens 1512), a converging lens 153, a lens 155, a filter element 160, and a light homogenizing element 170.

FIG. 2D and FIG. 2E are respectively schematic diagrams of an illumination system at different timings according to another embodiment of the disclosure. FIG. 2D is substantially the same as FIG. 2A, and FIG. 2E is substantially the same as FIG. 2B. The only difference between FIG. 2D and FIG. 2A is that the second light source 120 is disposed at the position of the original reflective mirror 136 of FIG. 2A, so the light combining module 130 of FIG. 2D does not need to additionally provide the reflective mirror 136, and the second beam L2 of the second light source 120 is directly incident on the light combining element 132. Similarly, the only difference between FIG. 2E and FIG. 2B is that the second light source 120 is disposed at the position of the original reflective mirror 136 of FIG. 2B, so the light combining module 130 of FIG. 2E does not need to additionally provide the reflective mirror 136, and the second beam 12 of the second light source 120 is directly incident on the light combining element 132.

Please continue to refer to FIG. 2A and FIG. 2B. The condenser lens 137 is disposed on the transmission path of the first beam L1 and the second beam L2 emitted from the light combining module 130 and is configured to converge the first beam L1 and the second beam L2 to be transmitted to the collimating lens 138 and then transmitted to the fly-eye lens array 139. The collimating lens 138 is configured to collimate the first beam L1 and the second beam L2 to be transmitted to the relay optical module 150 by the fly-eye lens array 139. The relay optical module 150 guides the first beam L1 and the second beam L2 to the condenser lens set 151 to be transmitted to the wavelength conversion element 140. Light transmission paths after the beams enter the wavelength conversion element 140 will be described with the timing diagram mentioned below.

FIG. 2F is a timing diagram of an illumination system according to an embodiment of the disclosure. Please continue to refer to FIG. 2A and FIG. 2B together with FIG. 2F. In the embodiment, the first light source 110 and the second light source 120 are both turned on, the wavelength conversion element 140 is a reflective wavelength conversion wheel, and the wavelength conversion element 140 has a non-wavelength conversion area and a wavelength conversion area, wherein the wavelength conversion area and the non-wavelength conversion area jointly form an annular region and enter the transmission path of the first beam L1 or/and the second beam L2 at different timings. When the wavelength conversion element 140 is in an I-area timing, the non-wavelength conversion area enters the transmission path of the first beam L1 or/and the second beam L2, the first beam L1 and the second beam L2 are reflected back to the condenser lens set 151 and back to the relay optical module 150 by the non-wavelength conversion area. After the relay optical module 150 transmits the first beam L1 and the second beam L2 to the condenser lens 153 and the lens 155, the filter element 160 transmits the first beam L1 and the second beam L2 to the light homogenizing element 170, as shown in FIG. 2A. When the wavelength conversion element 140 is in an II-area timing, the wavelength conversion area enters the transmission path of the first beam L1 or/and the second beam L2, and converts the first beam L1 into an excited beam L3 by the wavelength conversion area, and the excited beam L3 and the second beam L2 pass through the condenser lens set 151 and are then transmitted to the relay optical module 150. After the relay optical module 150 transmits the excited beam L3 and the second beam L2 to the condenser lens 153 and the lens 155, the filter element 160 transmits the excited beam L3 and the second beam L2 to the light homogenizing element 170, as shown in FIG. 2B. Thereby, the illumination beam LB includes at least one of the first beam L1, the second beam L2, and the excited beam L3. Specifically, the illumination beam LB includes the first beam L1 and the second beam L2 or the illumination beam LB includes the second beam L2 and the excited beam L3.

FIG. 2G is another timing diagram of an illumination system according to an embodiment of the disclosure. FIG. 2G is substantially the same as FIG. 2F, and the only difference is that in the implementation manner of FIG. 2G, the second light source 120 is turned off, that is, only the first beam L1 is used in the illumination system 100 to operate without providing the second beam L2. The timing when using the first light source 110 in FIG. 2G is the same as the implementation manner of FIG. 2F, so there will be no reiteration. In the embodiment, without a projection operation of an infrared light, the illumination system 100 only uses the first beam L1 and the excited beam L3. The illumination beam LB includes at least one of the first beam L1 and the excited beam L3. In a specific situation, such as in the case of simulated night vision, the infrared laser beam may be used to increase the line of sight effect, and the second light source 120 is turned on, but not limited to FIG. 2F and FIG. 2G. The following description will continue with the implementation manner of FIG. 2F.

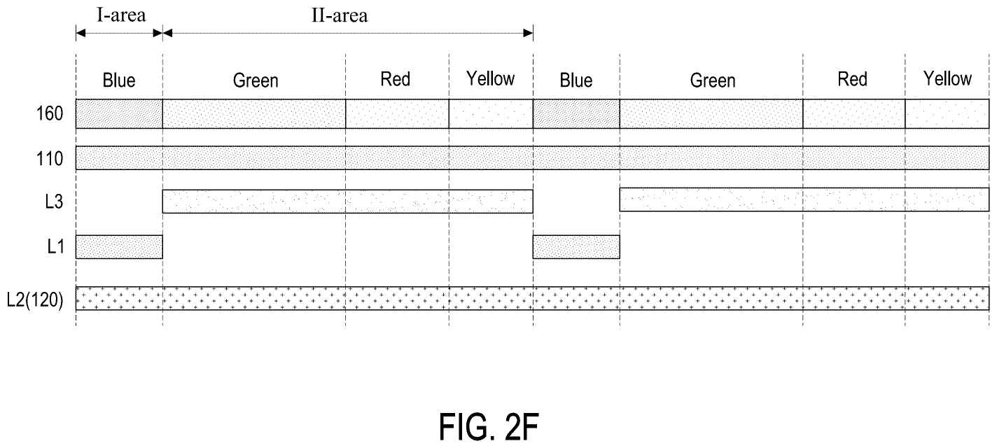

FIG. 3 is a schematic cross-sectional diagram of a wavelength conversion element according to an embodiment of the disclosure. Please refer to FIG. 2A, FIG. 2B, FIG. 2D, FIG. 2E, and FIG. 3. The wavelength conversion element 140 shown in FIG. 3 may at least be applied to the wavelength conversion element 140 shown in FIG. 2A, FIG. 2B, FIG. 2D, and FIG. 2E, so the following description takes this as an example. The wavelength conversion element 140 includes a rotary disk 142, a wavelength conversion material layer 144, and a light splitting layer 146, wherein the wavelength conversion material layer 144 and the light splitting layer 146 are disposed in the wavelength conversion area. The material of the rotary disk 142 is, for example, metal or other materials with beam reflecting ability. In the embodiment, the wavelength conversion area and the non-wavelength conversion area are also provided with a high reflective coating 148 on a surface of the rotary disk 142 to improve the reflection effect of the beams. The wavelength conversion material layer 144 is disposed on the rotary disk 142 and is configured to convert the incident first beam L1 into the excited beam L3.

The light splitting layer 146 is disposed on the rotary disk 142. The light splitting layer 146 is configured to reflect the second beam L2 and allow the first beam L1 and the excited beam L3 to pass through. In the embodiment, the wavelength conversion material layer 144 is disposed between the high reflective coating 148 and the light splitting layer 146, that is, the light splitting layer 146, the wavelength conversion material layer 144, and the high reflective coating 148 are sequentially disposed on the rotary disk 142. In an embodiment, if the rotary disk 142 is made of a material with beam reflecting ability, the wavelength conversion material layer 144 is disposed between the rotary disk 142 and the light splitting layer 146, that is, the high reflective coating 148 may not be disposed between the wavelength conversion material layer 144 and the rotary disk 142. In other words, since the second beam L2 is reflected by the light splitting layer 146, the wavelength conversion material layer 144 is not located on the transmission path of the second beam L2. The wavelength conversion material layer 144 is only disposed in the wavelength conversion area of the wavelength conversion element 140 and is configured to convert the first beam L1 into the excited beam L3. The high reflective coating 148 in the non-wavelength conversion area of the wavelength conversion element 140 is configured to reflect the first beam L1 and the second beam L2. If the rotary disk 142 is made of a material with beam reflecting ability, the non-wavelength conversion area may not be provided with the high reflective coating 148, and the first beam L1 and the second beam L2 are reflected by the rotary disk 142. Therefore, when the rotary disk 142 rotates, the first beam L1 is transmitted to the non-wavelength conversion area of the wavelength conversion element 140 in the I-area timing, the first beam L1 is reflected, the first beam L1 is transmitted to the wavelength conversion area in the II-area timing, and the wavelength conversion material layer 144 converts the first beam L1 into the excited beam L3. In the embodiment, the wavelength conversion material layer 144 includes, for example, a phosphor powder that excites a phosphor, and the wavelength conversion layer disposed in the wavelength conversion area is, for example, a phosphor powder that may excite a phosphor with one color or different phosphor powders that may excite phosphors with different colors. In the embodiment, the wavelength conversion layer disposed in the wavelength conversion area is, for example, a green phosphor powder that may excite a green light, a red phosphor powder that may excite a red light, and a yellow phosphor powder that may excite a yellow light, that is, when the green phosphor powder, the red phosphor powder, and the yellow phosphor powder on the wavelength conversion element 140 sequentially enter the transmission path of the first beam L1, the green, red, and yellow excited beams L3 may be converted at different timings. The light splitting layer 146 is, for example, an infrared reflective coating with a transmittance of greater than 90% for light with wavelengths of 400 nm to 680 nm and a reflectivity of greater than 90% for light with wavelengths of 700 nm to 1200 nm, and formed on a surface of the wavelength conversion material layer 144.

Therefore, when the first beam L1 and the second beam L2 pass through the light combining module 130 and are then transmitted to the wavelength conversion element 140 along the same transmission path, in the I-area timing, the first beam L1 and the second beam L2 are reflected by the non-wavelength conversion area not distributed with the wavelength conversion material layer 144. In the II-area timing, the first beam L1 passes through the light splitting layer 146 to generate the excited beam L3 by a region distributed with the wavelength conversion material layer 144, and the second beam L2 is reflected by the light splitting layer 146, so that the first beam L1 and the second beam L2 are output from the illumination system 100 as the illumination beam LB in the I-area timing, and the second beam L2 and the excited beam L3 are output from the illumination system 100 as the illumination beam LB in the II-area timing. In this way, the projection device 10 can provide an additional infrared light source for applications in different fields without adding an additional optical lens to maintain a good size. On the other hand, an existing model of the projection device 10 may also be upgraded, so that a housing of the existing model can continue to be used.

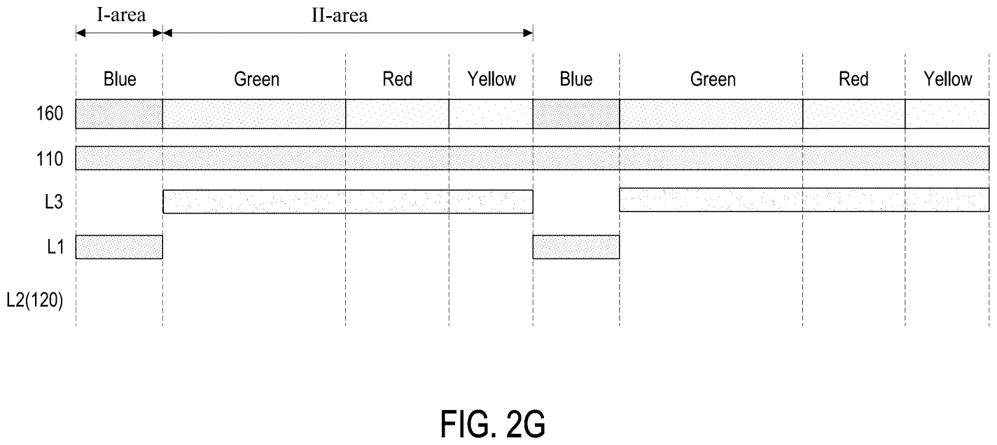

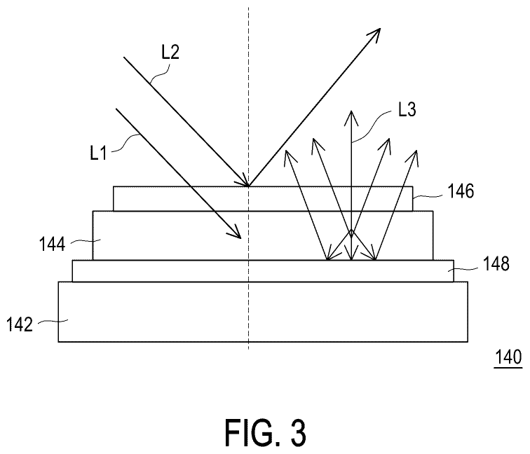

FIG. 4 is a schematic diagram of a light splitting element according to an embodiment of the disclosure. FIG. 5A and FIG. 5B are respectively wavelength transmittance curves of different regions in the light splitting element of FIG. 4. Please refer to FIG. 2A and FIG. 2B together with FIG. 4, FIG. 5A, and FIG. 5B. In the embodiment, the relay optical module 150 is disposed between the light combining module 130 and the wavelength conversion element 140.

The relay optical module 150 includes a light splitting element 152 and a reflective element 154. The light splitting element 152 is disposed on the transmission path of the first beam L1 and the second beam L2 between the light combining module 130 and the wavelength conversion element 140 and is configured to allow at least part of the first beam L1 and the second beam L2 to pass through and reflect and the excited beam L3. The reflective element 154 is disposed on the transmission path of the first beam L1 and the second beam L2 from the light splitting element 152 and is configured to reflect the first beam L1 and the second beam L2. The reflective element 154 is, for example, a reflective mirror.

In detail, the light splitting element 152 includes a first area A and a second area B1 connected to each other, wherein the first area A is configured to allow the first beam L1 and the second beam L2 to pass through and reflect the excited beam L3, and the second area B1 is configured to allow a part of the first beam L1 and the second beam L2 to pass through, reflect the other part of the first beam L1 and the second beam L2, and reflect the excited beam L3. Specifically, the first area A is located on the transmission path of the first beam L1 and the second beam L2 from the light combining module 130, and the second area B1 is located on the transmission path of the first beam L1 and the second beam L2 from the wavelength conversion element 140. For example, the first area A, for example, has a coating reflecting the excited beam L3 and is configured to allow the first beam L1 and the second beam L2 to pass through, and a corresponding transmittance versus wavelength curve 200 thereof is as shown in FIG. 5A. The second area B1, for example, has a coating reflecting the excited beam L3 and has a semi-reflective and semi-transmissive coating for the first beam L1 and the second beam L2 to be respectively half transmitted and half reflected, and a corresponding transmittance versus wavelength curve 201 thereof is shown in FIG. 5B, that is, the transmittance of the first area A to the first beam L1 and the second beam L2 is greater than the transmittance of the second area B1 to the first beam L1 and the second beam L2. By adjusting the design of the spatial proportion distribution of the first area A and the second area B1 or the reflectivity of the second area B1, the energies of the beams respectively emitted by the first area A and the second area B1 may be the same.

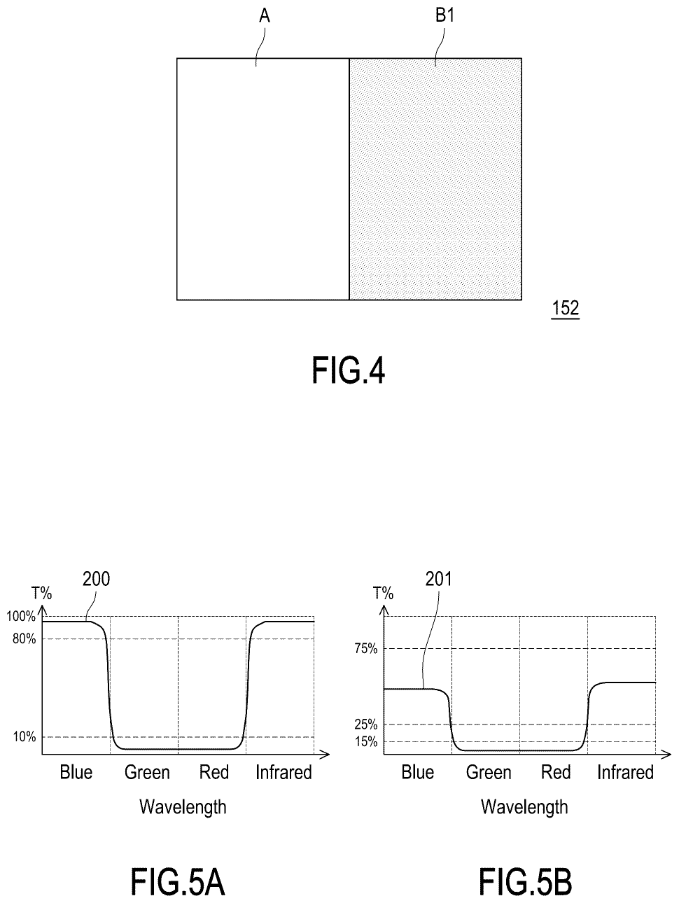

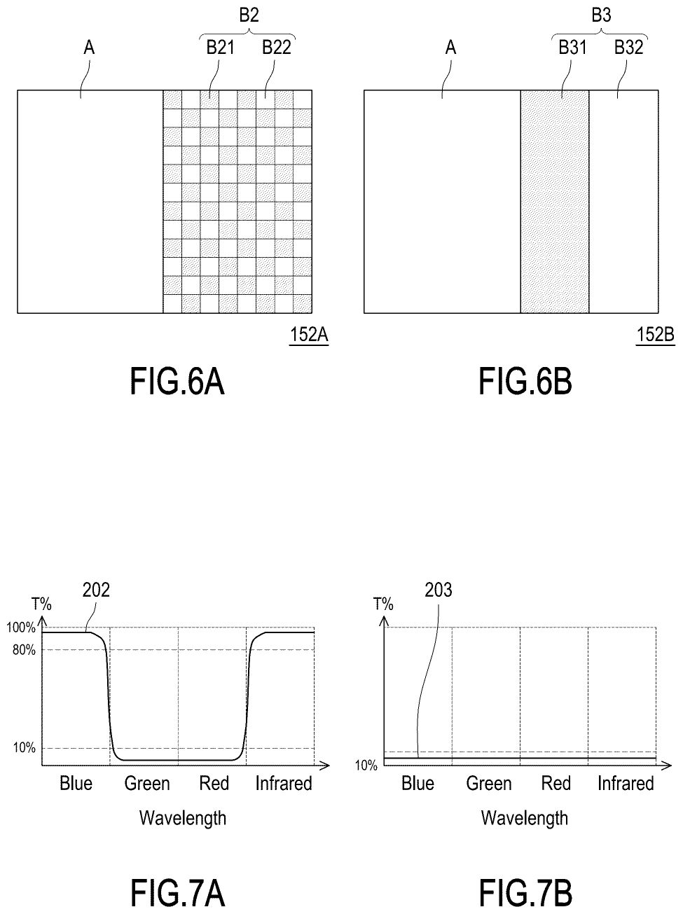

FIG. 6A and FIG. 6B are respectively schematic diagrams of a light splitting element according to different embodiments of the disclosure. FIG. 7A and FIG. 7B are respectively wavelength transmittance curves of different regions in the light splitting element of FIG. 6A. Please refer to FIG. 6A to FIG. 7B. In other embodiments, the second area B2 in the light splitting element 152A includes at least one first sub-area B21 and at least one second sub-area B22. In an embodiment, areas of the at least one first sub-area B21 and the at least one second sub-area B22 are substantially the same. In the embodiment shown in FIG. 6A, the numbers of the at least one first sub-area B21 and the at least one second sub-area B22 are both multiple, and the first sub-areas B21 and the second sub-areas B22 are in a staggered arrangement with a checkerboard shape. The first sub-area B21 is, for example, the same as the first area A and is configured to allow the first beam L1 and the second beam L2 to pass through and reflect the excited beam L3, and a corresponding transmittance versus wavelength curve 202 thereof is as shown in FIG. 7A. The second sub-area B22 is configured to reflect the first beam L1, the second beam L2, and the excited beam L3, and has, for example, a reflective coating, and a corresponding transmittance versus wavelength curve 203 thereof is as shown in FIG. 7B. In another embodiment, as shown in FIG. 6B, the numbers of the first sub-area B31 and the second sub-area B32 of the second area B3 are respectively one, and the first sub-area B31 and the second sub-area are adjacently arranged in a strip shape. Transmittance versus wavelength curves respectively corresponding to the first sub-area B31 and the second sub-area B32 are the same as the curves 202 and 203 of the previous embodiment, that is, one area allows the first beam L1 and the second beam L2 to pass through and reflects the excited beam L3, and the other area reflects the first beam L1, the second beam L2, and the excited beam L3, as shown in FIG. 7A and FIG. 7B.

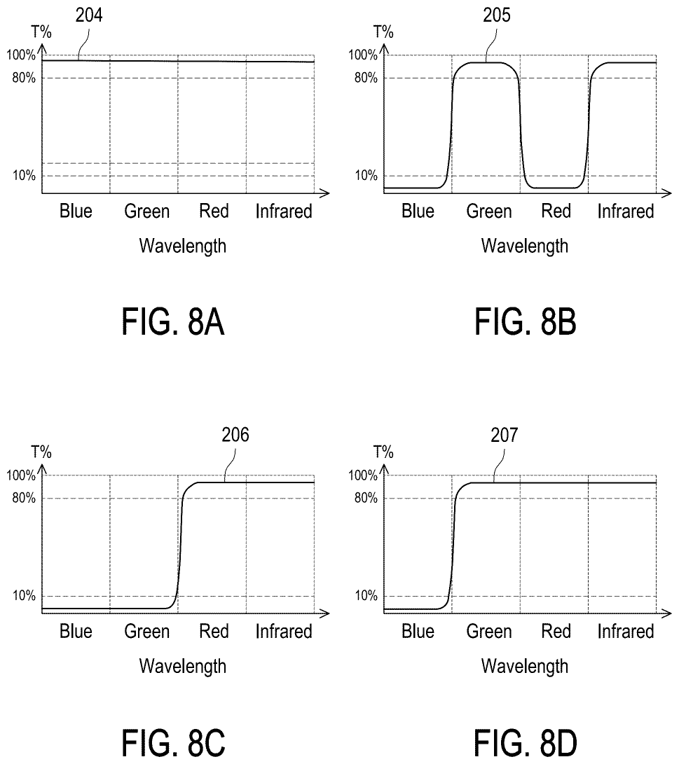

FIG. 8A to FIG. 8D are respectively wavelength transmittance curves of different regions in a filter element according to an embodiment of the disclosure. Please refer to FIG. 2A, FIG. 2B, and FIG. 8A to FIG. 8D. The filter element 160 is disposed on a transmission path of the first beam L1, the second beam L2, and the excited beam L3, and is configured to sequentially allow the first beam L1 and the second beam L2 and the second beam L2 and the excited beam L3 to pass through. Specifically, the filter element 160 is disposed on the transmission path of the first beam L1, the second beam L2, and the excited beam L3 from the relay optical module 150. The filter element 160 is, for example, a filter wheel, and different filter regions are disposed in different regions of the rotary disk. For example, in the embodiment, the filter element 160 includes a light transmission area, a green light filter area, a red light filter area, and a yellow light filter area. The light transmission area is configured to allow beams to pass through, and a corresponding transmittance versus wavelength curve 204 thereof is as shown in FIG. 8A. The green light filter area is configured to allow a green light in a specific waveband range to pass through and reflect a blue light and a red light, and a corresponding transmittance versus wavelength curve 205 thereof is as shown in FIG. 8B. The red light filter area is configured to allow a red light in a specific waveband range and light with a wavelength above the wavelength of the red light to pass through and reflect a green light and light with a wavelength below the wavelength of the green light, and a corresponding transmittance versus wavelength curve 206 thereof is as shown in FIG. 8C. The yellow light filter area is configured to allow a green light in a specific waveband range and light with a wavelength above the wavelength of the green light to pass through and reflect the blue light, and a corresponding transmittance versus wavelength curve 207 thereof is as shown in FIG. 8D. In the embodiment, the second beam L2 (the infrared light) may pass through the filter element 160 at all timings.

The light homogenizing element 170 is disposed on a transmission path of a beam from the filter element 160 and is configured to adjust the shape of light spots of the illumination beam LB, so that the shape of light spots of the illumination beam LB can match the shape (for example, rectangular) of a working area of a light valve, and the light spots have consistent or close light intensity everywhere to homogenize the light intensity of the illumination beam LB. In the embodiment, the light homogenizing element 170 is, for example, an integrating rod, but in other embodiments, the light homogenizing element 170 may also be other appropriate types of optical elements, such as a lens array (a fly-eye lens array), but the disclosure is not limited thereto.

Please refer to FIG. 1 and FIG. 2F again. In conjunction with the descriptions in the above paragraphs, in the embodiment, the timings may be divided into four different types: the blue light, the green light, the red light, and the yellow light. Specifically, in the timing from the blue light to the yellow light, the first light source 110 and the second light source 120 are both on, and in the timing of the blue light, when the first beam L1 and the second beam L2 are transmitted to the wavelength conversion element 140, the wavelength conversion element 140 reflects the first beam L1 and the second beam L2, and the second beam L2 and the first beam L1 pass through the light transmission area of the filter element 160 and then enter the light homogenizing element 170, thereby becoming the illumination beam LB (the blue light and the infrared light). In the timing of the green light, when the first beam L1 and the second beam L2 are transmitted to the wavelength conversion element 140, the wavelength conversion element 140 reflects the second beam L2, the wavelength conversion element 140 converts the first beam L1 into the green excited beam L3, and the second beam L2 and the green excited beam L3 pass through the green light filter area of the filter element 160 and then enter the light homogenizing element 170, thereby becoming the illumination beam LB (the green light and the infrared light). In the timing of the red light, when the first beam L1 and the second beam L2 are transmitted to the wavelength conversion element 140, the wavelength conversion element 140 reflects the second beam L2, the wavelength conversion element 140 converts the first beam L1 into the red excited beam L3, and the second beam L2 and the red excited beam L3 pass through the red light filter area of the filter element 160 and then enter the light homogenizing element 170, thereby becoming the illumination beam LB (the red light and the infrared light). In the timing of the yellow light, when the first beam L1 and the second beam L2 are transmitted to the wavelength conversion element 140, the wavelength conversion element 140 reflects the second beam L2, the wavelength conversion element 140 converts the first beam L1 into the yellow excited beam L3, and the second beam L2 and the yellow excited beam L3 pass through the yellow light filter area of the filter element 160 and then enter the light homogenizing element 170, thereby becoming the illumination beam LB (the yellow light and the infrared light).

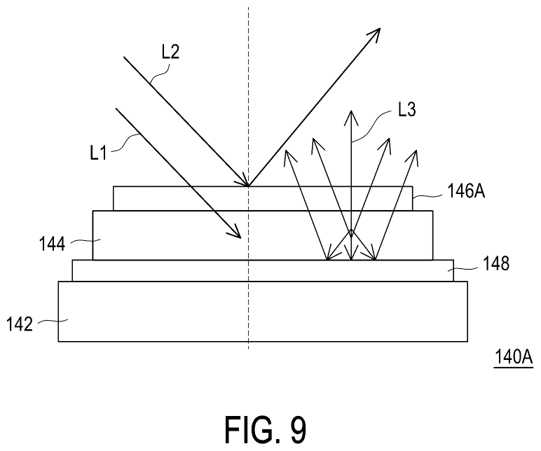

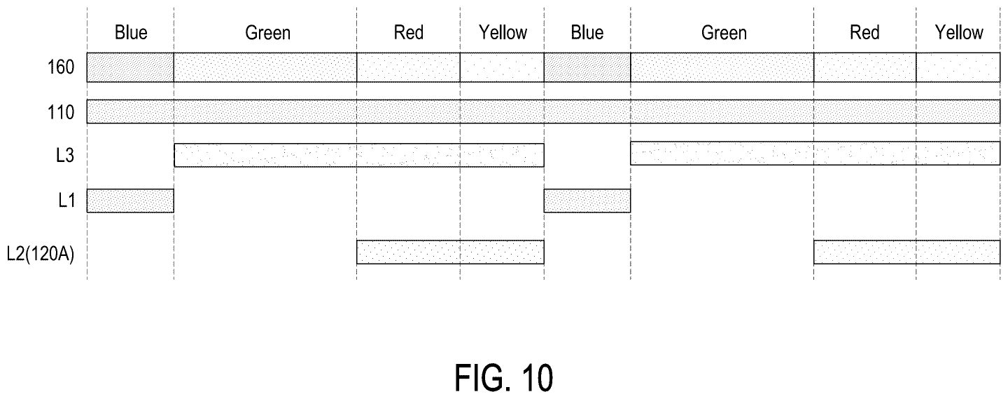

FIG. 9 is a schematic cross-sectional diagram of a wavelength conversion element according to another embodiment of the disclosure. FIG. 10 is a timing diagram of an illumination system according to another embodiment of the disclosure. Please refer to FIG. 2A, FIG. 2B, FIG. 9, and FIG. 10. A wavelength conversion element 140A shown in the embodiment is similar to the wavelength conversion element 140 shown in FIG. 2A and FIG. 2B. The difference between the two is that in the embodiment, a second light source 120A of an illumination system is selected as a red light emitting diode or laser diode, and the second beam L2 provided by the second light source 120A is, for example, a red laser beam with a dominant wavelength of 638 nm. A light splitting layer 146A of the wavelength conversion element 140A is, for example, changed to a red light reflective coating with a transmittance of greater than 90% for light with a wavelength of 400 nm to 600 nm and a reflectivity of greater than 90% for light with a wavelength greater than 600 nm. Therefore, in the timing from the blue light to the yellow light, the second light source 120A is only turned on in the timing of the red light and the timing of the yellow light, as shown in FIG. 10. The illumination beam is at least one of the first beam, the second beam (the red light), and the excited beam. In this way, the optical quality of the red light and the yellow light in the illumination system can be additionally improved without adding an additional optical lens to maintain a good size. On the other hand, the existing model of the projection device may also be upgraded, so that the housing of the existing model can continue to be used.

In summary, in the illumination system and the projection device of the disclosure, the illumination system includes the first light source, the second light source, the light combining module, and the wavelength conversion element. The first light source is configured to provide the first beam, and the second light source is configured to provide the second beam. When the first beam and the second beam pass through the light combining module at the same time or at different times and are then transmitted to the wavelength conversion element along the same transmission path, the first beam passes through the light splitting layer to generate the excited beam by the region distributed with the wavelength conversion material layer or to be reflected by the region not distributed with the wavelength conversion material layer, and the second beam is reflected by the light splitting layer or is reflected by the region not distributed with the wavelength conversion material layer, so that the first beam, the second beam, and the excited beam respectively form the illumination beam according to the same or different timings. In this way, the projection device can provide the additional infrared light for applications in different fields without adding an additional optical lens to maintain a good size. On the other hand, the existing projection device model may also be upgraded, so that the housing of the existing model can continue to be used.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the disclosure” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be configured to interpret or limit the scope or meaning of the claims. Any advantages and benefits described may not apply to all embodiments of the invention. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. An illumination system, configured to provide an illumination beam, the illumination system comprising a first light source, a second light source, a light combining module, and a wavelength conversion element, wherein:
the first light source is configured to provide a first beam, and the first beam is a laser beam;
the second light source is configured to provide a second beam, a wavelength range of the first beam is different from a wavelength range of the second beam, and the light combining module is disposed on a transmission path of the first beam from the first light source and the second beam from the second light source, so that the first beam and the second beam have the same transmission path between the light combining module and the wavelength conversion element; and
the wavelength conversion element comprises a rotary disk, a wavelength conversion material layer, and a light splitting layer, wherein:
the light splitting layer is disposed on the rotary disk, and the wavelength conversion material layer is disposed between the rotary disk and the light splitting layer;
the wavelength conversion material layer is configured to convert the first beam into an excited beam; and
the light splitting layer is configured to reflect the second beam and allow the first beam and the excited beam to pass through, wherein when the first light source is turned on and the second light source is turned off, the illumination beam comprises at least one of the first beam and the excited beam, and when the first light source and the second light source are both turned on, the illumination beam comprises at least one of the first beam, the second beam, and the excited beam.

2. The illumination system according to claim 1, wherein the second beam is an infrared light or a red light with a dominant wavelength of 638 nm.

3. The illumination system according to claim 1, wherein the light combining module comprises a light combining element, and the first beam from the first light source and the second beam from the second light source are respectively incident from two opposite sides of the light combining element, wherein one of the first beam and the second beam is reflected by the light combining element, and other one of the first beam and the second beam passes through the light combining element.

4. The illumination system according to claim 3, wherein the light combining element comprises a plurality of strip-shaped coating areas and a plurality of strip-shaped non-coating areas in a staggered arrangement, wherein each of the strip-shaped coating areas is configured to reflect the second beam and allow the first beam to pass through.

5. The illumination system according to claim 1, wherein the illumination system further comprises a relay optical module, and the relay optical module comprises a light splitting element and a reflective element, wherein:
the light splitting element is disposed on the transmission path of the first beam and the second beam between the light combining module and the wavelength conversion element and is configured to allow at least part of the first beam and the second beam to pass through and reflect the excited beam; and
the reflective element is disposed on a transmission path of the first beam and the second beam from the light splitting element and is configured to reflect the first beam and the second beam.

6. The illumination system according to claim 5, wherein the light splitting element comprises a first area and a second area connected to each other, wherein:
the first area is configured to allow the first beam and the second beam to pass through and reflect the excited beam; and
the second area is configured to allow a part of the first beam and the second beam to pass through and reflect other part of the first beam and the second beam and the excited beam.

7. The illumination system according to claim 6, wherein the second area comprises at least one first sub-area and at least one second sub-area, wherein:
the at least one first sub-area is configured to allow the first beam and the second beam to pass through and reflect the excited beam; and
the at least one second sub-area is configured to reflect the first beam, the second beam, and the excited beam.

8. The illumination system according to claim 7, wherein areas of the at least one first sub-area and the at least one second sub-area are substantially the same.

9. The illumination system according to claim 7, wherein numbers of the at least one first sub-area and the at least one second sub-area are both plural, and the first sub-areas and the second sub-areas are in a staggered arrangement with a strip shape or a checkerboard shape.

10. The illumination system according to claim 1, wherein the illumination system further comprises a filter element, wherein:
the filter element is disposed on a transmission path of the first beam, the second beam, and the excited beam and is configured to sequentially allow the first beam, the second beam, and the excited beam to pass through.

11. A projection device comprising an illumination system, at least one light valve, and a projection lens, wherein:
the illumination system is configured to provide an illumination beam, and the illumination system comprises a first light source, a second light source, a light combining module, and a wavelength conversion element, wherein:
the first light source is configured to provide a first beam, and the first beam is a laser beam;
the second light source is configured to provide a second beam, a wavelength range of the first beam is different from a wavelength range of the second beam, and the light combining module is disposed on a transmission path of the first beam from the first light source and the second beam from the second light source, so that the first beam and the second beam have the same transmission path between the light combining module and the wavelength conversion element; and
the wavelength conversion element comprises a rotary disk, a wavelength conversion material layer, and a light splitting layer, wherein:
the light splitting layer is disposed on the rotary disk, and the wavelength conversion material layer is disposed between the rotary disk and the light splitting layer;
the wavelength conversion material layer is configured to convert the first beam into an excited beam; and
the light splitting layer is configured to reflect the second beam and allow the first beam and the excited beam to pass through, wherein when the first light source is turned on and the second light source is turned off, the illumination beam comprises at least one of the first beam and the excited beam, and when the first light source and the second light source are both turned on, the illumination beam comprises at least one of the first beam, the second beam, and the excited beam;
the at least one light valve is disposed on a transmission path of the illumination beam and is configured to convert the illumination beam into an image beam; and
the projection lens is disposed on a transmission path of the image beam and is configured to project the image beam out of the projection device.

12. The projection device according to claim 11, wherein the second beam is an infrared light or a red light with a dominant wavelength of 638 nm.

13. The projection device according to claim 11, wherein the light combining module comprises a light combining element, and the first beam from the first light source and the second beam from the second light source are respectively incident from two opposite sides of the light combining element, wherein one of the first beam and the second beam is reflected by the light combining element, and other one of the first beam and the second beam passes through the light combining element.

14. The projection device according to claim 13, wherein the light combining element comprises a plurality of strip-shaped coating areas and a plurality of strip-shaped non-coating areas in a staggered arrangement, wherein each of the strip-shaped coating areas is configured to reflect the second beam and allow the first beam to pass through.

15. The projection device according to claim 11, wherein the illumination system further comprises a relay optical module, and the relay optical module comprises a light splitting element and a reflective element, wherein:
the light splitting element is disposed on the transmission path of the first beam and the second beam between the light combining module and the wavelength conversion element and is configured to allow at least part of the first beam and the second beam to pass through and reflect the excited beam; and
the reflective element is disposed on a transmission path of the first beam and the second beam from the light splitting element and is configured to reflect the first beam and the second beam.

16. The projection device according to claim 15, wherein the light splitting element comprises a first area and a second area connected to each other, wherein:
the first area is configured to allow the first beam and the second beam to pass through and reflect the excited beam; and
the second area is configured to allow a part of the first beam and the second beam to pass through and reflect other part of the first beam and the second beam and the excited beam.

17. The projection device according to claim 16, wherein the second area comprises at least one first sub-area and at least one second sub-area, wherein:
the at least one first sub-area is configured to allow the first beam and the second beam to pass through and reflect the excited beam; and
the at least one second sub-area is configured to reflect the first beam, the second beam, and the excited beam.

18. The projection device according to claim 17, wherein areas of the at least one first sub-area and the at least one second sub-area are substantially the same.

19. The projection device according to claim 17, wherein numbers of the at least one first sub-area and the at least one second sub-area are both plural, and the first sub-areas and the second sub-areas are in a staggered arrangement with a strip shape or a checkerboard shape.

20. The projection device according to claim 11, wherein the illumination system further comprises a filter element, wherein:
the filter element is disposed on a transmission path of the first beam, the second beam, and the excited beam and is configured to sequentially allow the first beam, the second beam, and the excited beam to pass through.
